(19) United States
(12) Patent Application Publication
(10) Pub. No.: US 2024/0388039 A1
(43) Pub. Date: Nov. 21, 2024

(54) ELECTRICAL CONNECTOR WITH FOOL-PROOF FUNCTION AND IMPROVED STRUCTURAL STABILITY

(71) Applicant: DONGGUAN LUXSHARE TECHNOLOGIES CO., LTD, Dongguan City (CN)

(72) Inventor: Hongji Chen, Dongguan City (CN)

(73) Assignee: DONGGUAN LUXSHARE TECHNOLOGIES CO., LTD, Dongguan City (CN)

(21) Appl. No.: 18/601,285

(22) Filed: Mar. 11, 2024

(30) Foreign Application Priority Data
May 17, 2023 (CN) 202321201540.7

(51) Int. Cl. H01R 13/642; H01R 13/04; H01R 13/424; H01R 13/6581

(52) U.S. Cl. CPC H01R 13/642; H01R 13/04; H01R 13/424; H01R 13/6581

(57) ABSTRACT

An electrical connector includes an insulating body, a number of conductive terminals and a shielding shell. The insulating body includes a mating surface and a slot extending through the mating surface. Each conductive terminal includes a contact portion extending into the slot. A receiving groove for accommodating a mating connector is formed between the shielding shell and the insulating body. The shielding shell includes a first shell portion. The first shell portion includes a first outer surface, a first end surface and a fool-proof protrusion. The fool-proof protrusion has a first edge located at a most end thereof. The first end surface and the first end edge are disposed one behind the other. The fool-proof protrusion is configured to prevent the mating connector from being inserted into the electrical connector at a wrong angle.

### CROSS-REFERENCE TO RELATED APPLICATION

This patent application claims priority of a Chinese Patent Application No. 202321201540.7, filed on May 17, 2023 and titled “ELECTRICAL CONNECTOR”, the entire content of which is incorporated herein by reference.

### TECHNICAL FIELD

The present disclosure relates to an electrical connector which belongs to a technical field of connectors.

### BACKGROUND

An existing electrical connector assembly usually includes a plug connector (a male connector) and a socket connector (a female connector) that are mated with each other. It is known that data and/or power transmission can only be realized when the plug connector and the socket connector are correctly mated. If the plug connector and the receptacle connector are mated at a wrong angle (for example, the plug connector is flipped 180 degrees and inserted backwardly into the socket connector), firstly the transmission function cannot be realized, and secondly terminals are easily to be damaged.

In order to solve the above technical problem, electrical connectors with a fool-proof function have appeared in the related art in order to protect the terminals from being damaged due to incorrect insertion of a mating connector. The shell of the electrical connector is provided with an outwardly protruding fool-proof protrusion. The fool-proof protrusion is configured to abut against the plug connector when the plug connector is inserted into the electrical connector at a wrong angle, so as to prevent further insertion of the plug connector.

Specifically, the shell has a front face, the fool-proof protrusion has a front edge, and the front edge is flush with the front surface. However, this kind of design tends to cause a large deformation on the front end of the shell when forming (such as stamping) the fool-proof protrusion, which affects the sensitive dimensions of a frame opening of the electrical connector, resulting in a high defect rate.

### SUMMARY

An object of the present disclosure is to provide an electrical connector with a fool-proof function and improved structural stability.

In order to achieve the above object, the present disclosure adopts the following technical solution: an electrical connector, including: an insulating body including a mating surface and a slot extending through the mating surface along a first direction, the slot being configured to receive a part of a mating connector along a second direction opposite to the first direction; a plurality of conductive terminals, each conductive terminal including a contact portion extending into the slot; and a shielding shell shielded on the insulating body, a receiving groove for receiving a part of the mating connector being formed between the shielding shell and the insulating body, the receiving groove being located outside the slot along a third direction which is perpendicular to the first direction and the second direction; wherein the shielding shell includes a first shell portion, the first shell portion includes a first outer surface, a first end surface located adjacent to the mating surface along the first direction, and a fool-proof protrusion protruding beyond the first outer surface along a fourth direction which is opposite to the third direction; the fool-proof protrusion is located adjacent to the mating surface; the first outer surface and the receiving groove are located on opposite sides of the slot, respectively; the fool-proof protrusion has a first end edge located at a most end along the first direction; the first end surface and the first end edge are disposed one behind the other along the second direction; and the fool-proof protrusion is configured to prevent the mating connector from being inserted into the electrical connector at a wrong angle.

In order to achieve the above object, the present disclosure adopts the following technical solution: an electrical connector, including: an insulating body including a mating surface and a slot extending through the mating surface along a first direction, the slot being configured to receive a part of a mating connector along a second direction opposite to the first direction; a plurality of conductive terminals, each conductive terminal including an elastic contact portion extending into the slot; and a shielding shell made of a metal material and shielded on the insulating body, a receiving groove for receiving a part of the mating connector being formed between the shielding shell and the insulating body, the receiving groove being located outside the slot along a third direction which is perpendicular to the first direction and the second direction; wherein the shielding shell includes a first shell portion, the first shell portion includes a first outer surface, a first end surface located adjacent to the mating surface along the first direction, and a fool-proof protrusion protruding beyond the first outer surface along a fourth direction which is opposite to the third direction; the fool-proof protrusion is integrally stamped from the first shell portion and located adjacent to the mating surface; the first outer surface and the receiving groove are located on opposite sides of the slot, respectively; the fool-proof protrusion has a first end edge located at a most end along the first direction; the first end surface and the first end edge are located on different planes; and the fool-proof protrusion is configured to prevent the mating connector from being inserted into the electrical connector at a wrong angle.

Compared with the prior art, the present disclosure provides a fool-proof protrusion protruding beyond the first outer surface, and the fool-proof protrusion is used to prevent the mating connector from being inserted into the electrical connector at a wrong angle, thereby protecting the electrical connector of the present disclosure. In addition, the first end surface of the shielding shell and the first end edge of the fool-proof protrusion are arranged one behind the other along the second direction, which reduces the over-influence on sensitive dimensions of a frame opening of the shielding shell during forming of the fool-proof protrusion, thereby improving the structural stability of the shielding shell.

### BRIEF DESCRIPTION OF DRAWINGS

FIG. 1 is a perspective schematic view of an electrical connector in accordance with a first embodiment of the present disclosure;

FIG. 2 is a front view of FIG. 1;

FIG. 3 is a partially exploded perspective view of FIG. 1;

FIG. 4 is a partially exploded perspective view of FIG. 3 from another angle;

FIG. 5 is a right side view of a shielding shell in FIG. 3;

FIG. 6 is a right side view of a first terminal module, a second terminal module, a grounding member and a positioning block in FIG. 3 when they are combined together;

FIG. 7 is a perspective exploded view of the first terminal module, the second terminal module, the grounding member and the positioning block in FIG. 4;

FIG. 8 is a perspective exploded view of FIG. 7 from another angle;

FIG. 9 is a schematic view when a mating connector is inserted into the electrical connector of the present disclosure at a correct angle (for example, a normal insertion);

FIG. 10 is a schematic view when the mating connector is inserted into the electrical connector of the present disclosure at a wrong angle (for example, a reverse insertion);

FIG. 11 is a schematic cross-sectional view taken along line B-B in FIG. 1;

FIG. 12 is a partial enlarged view of a frame part C in FIG. 11;

FIG. 13 is a perspective schematic view of the electrical connector in accordance with a second embodiment of the present disclosure;

FIG. 14 is a front view of FIG. 13;

FIG. 15 is a top view of FIG. 13;

FIG. 16 is a right view of FIG. 13;

FIG. 17 is a schematic perspective view of the electrical connector in accordance with a third embodiment of the present disclosure;

FIG. 18 is a front view of FIG. 17;

FIG. 19 is a top view of FIG. 17; and

FIG. 20 is a right side view of FIG. 17.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

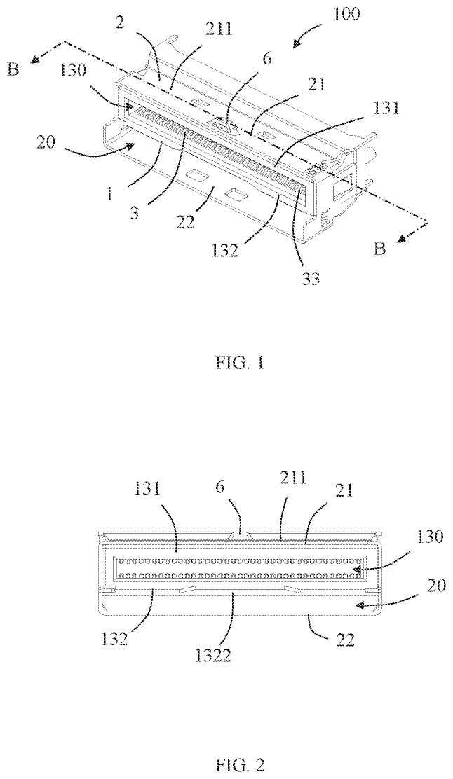

Referring to FIGS. 1 to 4, the present disclosure discloses an electrical connector 100 for being mounted to a circuit board (not shown). The electrical connector 100 can be applied to devices such as switches, servers, data centers, etc., to transmit data. The electrical connector 100 includes an insulating body 1, a shielding shell 2 shielded on the insulating body 1, and a plurality of conductive terminals 3 extending into the insulating body 1.

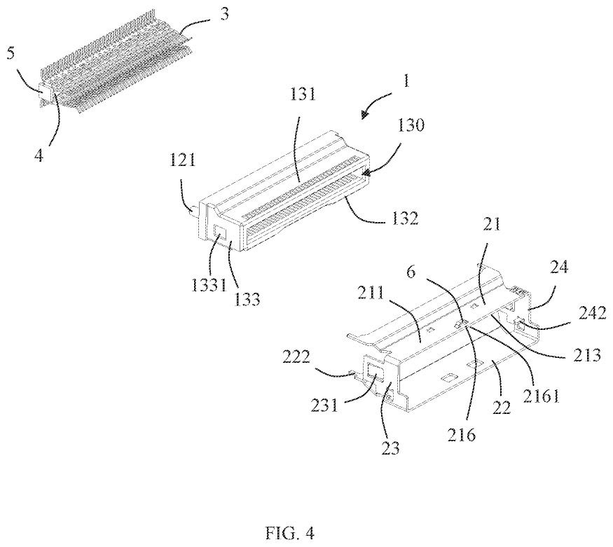

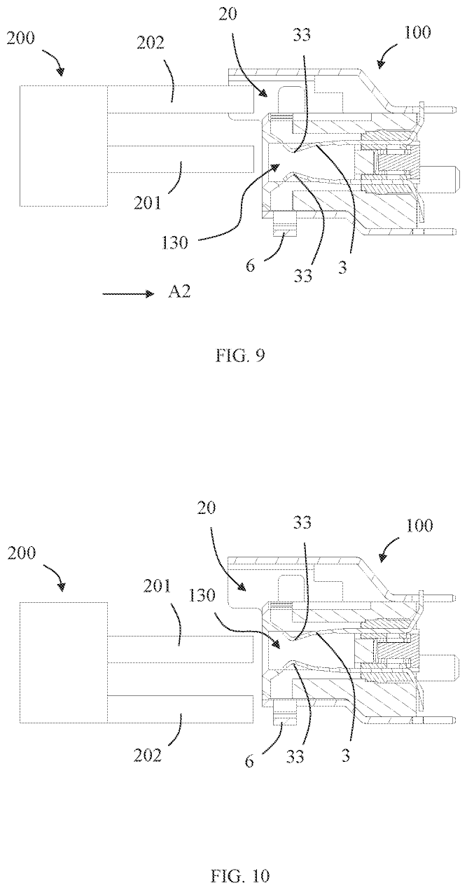

Referring to FIGS. 3 and 4, the insulating body 1 includes a mating surface 11, a mounting surface 12 opposite to the mating surface 11, and a frame portion 13. The frame portion 13 includes a first wall portion 131, a second wall portion 132 opposite to the first wall portion 131, a third wall portion 133 connecting one side of the first wall portion 131 and one side of the second wall portion 132, and a fourth wall portion 134 connecting the other side of the first wall portion 131 and the other side of the second wall portion 132. The first wall portion 131, the second wall portion 132, the third wall portion 133 and the fourth wall portion 134 together form a slot 130 for receiving a part of the mating connector 200 along a second direction A2 (referring to FIG. 9). The slot 130 extends through the mating surface 11 along a first direction A1. The first direction A1 is opposite to the second direction A2, for example, the first direction A1 is a rear-to-front direction, and the second direction A2 is a front-to-rear direction. The first wall portion 131 defines a plurality of first terminal grooves 1311. The second wall portion 132 defines a plurality of second terminal grooves 1321. The insulating body 1 includes a plurality of positioning protrusions 121 protruding backwardly beyond the mounting surface 12 for mounting the electrical connector 100 to the circuit board. The third wall portion 133 defines a plurality of first grooves 1331. The fourth wall portion 134 defines a plurality of second grooves 1341. A bottom surface of the second wall portion 132 further includes a recessed portion 1322 recessed toward the first wall portion 131 for mating with the mating connector 200.

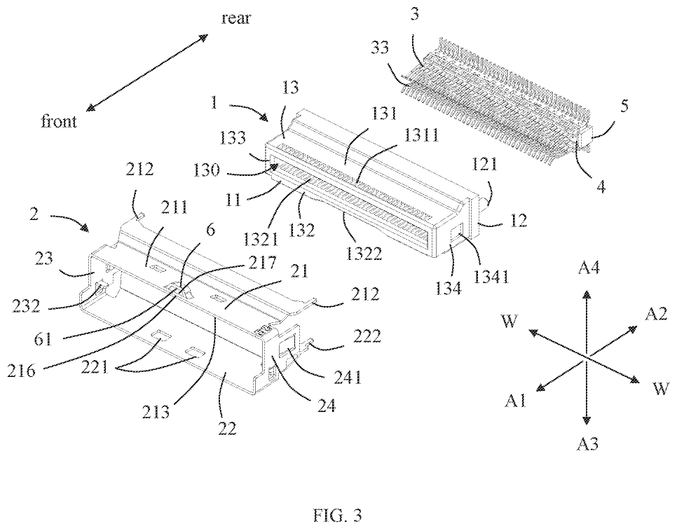

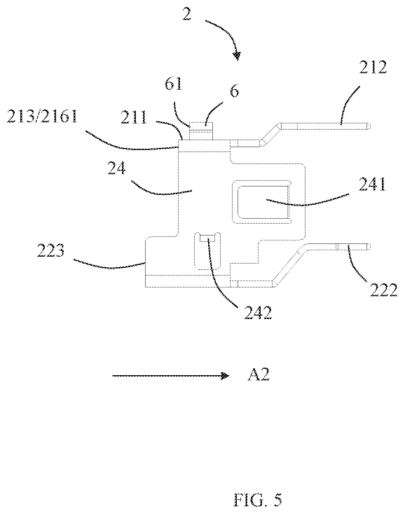

Referring to FIGS. 3 to 5, in the illustrated embodiment of the present disclosure, the shielding shell 2 is made of a metal material. The shielding shell 2 includes a first shell portion 21, a second shell portion 22 opposite to the first shell portion 21, a third shell portion 23 connecting one side of the first shell portion 21 and one side of the second shell portion 22, and a fourth shell portion 24 connecting the other side of the first shell portion 21 and the other side of the second shell portion 22. The first shell portion 21 abuts on the first wall portion 131. The first shell portion 21 includes a first outer surface 211 (for example, a top surface). The first shell portion 21 further includes a plurality of first mounting feet 212 extending backwardly beyond the mounting surface 12. The first mounting feet 212 is used to mount the electrical connector 100 to the circuit board. The second shell portion 22 extends forwardly beyond the first shell portion 21. The second shell portion 22 and the second wall portion 132 are separated by a certain distance, thereby forming a receiving groove 20 between the second shell portion 22 and the second wall portion 132 (referring to FIGS. 1 and 2). The receiving groove 20 is adapted to receive a part of the mating connector 200. The second shell portion 22 further includes at least one locking hole 221 in communication with the receiving groove 20. The locking hole 221 is adapted for locking with a locking protrusion of the mating connector 200 so as to ensure that the electrical connector 100 and the mating connector 200 are reliably connected together and prevent them from being improperly separated. The receiving groove 20 is located outside the slot 130 along a third direction A3. The receiving groove 20 is independent of the slot 130. The third direction A3 is perpendicular to the first direction A1 and the second direction A2. In the illustrated embodiment of the present disclosure, the receiving groove 20 and the slot 130 are separated by the second wall portion 132.

The first outer surface 211 and the receiving groove 20 are located on two sides (for example, an upper side and a lower side) of the slot 130, respectively. The second shell portion 22 includes a plurality of second mounting feet 222 extending backwardly beyond the mounting surface 12. The second mounting feet 222 are adapted to mount the electrical connector 100 to the circuit board. In addition, the third shell portion 23 includes a first clamping piece 231 which is clamped into the first groove 1331, and the fourth shell portion 24 includes a second clamping piece 241 which is clamped into the second groove 1341, so that the shielding shell 2 is prevented from being separated from the insulating body 1. In addition, the third shell portion 23 and/or the fourth shell portion 24 also includes protrusions 232, 242 which are engaged with the insulating body 1 to further prevent the shielding shell 2 from being separated from the insulating body 1.

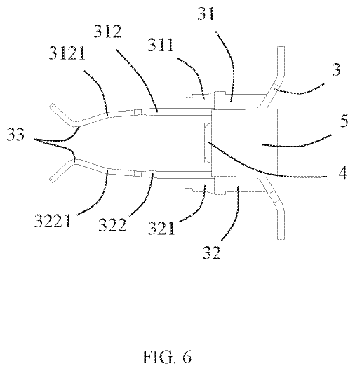

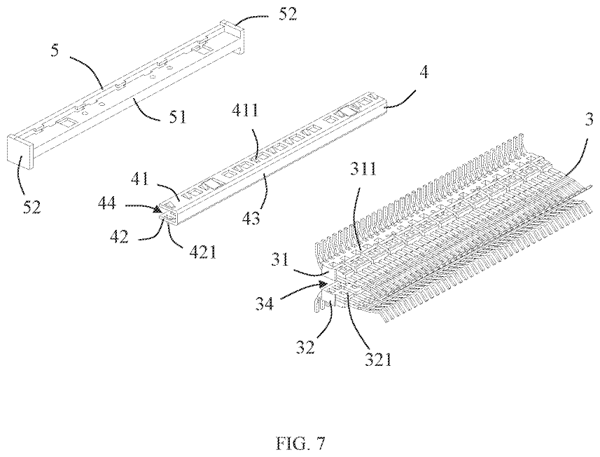

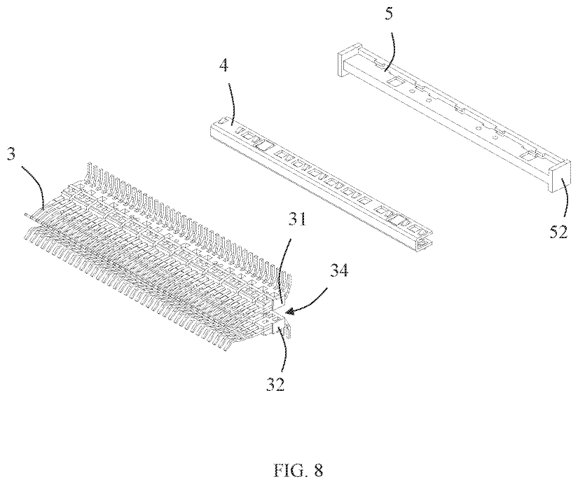

Referring to FIGS. 6 to 8, in the illustrated embodiment of the present disclosure, the electrical connector 100 includes a first terminal module 31 and a second terminal module 32 which are assembled to the insulating housing 1. The first terminal module 31 includes a first insulating block 311 and a plurality of first conductive terminals 312 fixed to the first insulating block 311. The second terminal module 32 includes a second insulating block 321 and a plurality of second conductive terminals 322 fixed to the second insulating block 321. The first conductive terminals 312 include a plurality of first elastic arms 3121 corresponding to the first terminal grooves 1311 and protruding beyond the first wall portion 131. The second conductive terminals 322 include a plurality of second elastic arms 3221 corresponding to the second terminal grooves 1321 and protruding beyond the second wall portion 132. Each of the first elastic arms 3121 and the second elastic arms 3221 extends into the slot 130, and includes a contact portion 33 for mating with the mating connector 200.

Referring to FIGS. 6 to 8, a spacing groove 34 is formed between the first insulating block 311 and the second insulating block 321. The electrical connector 100 further includes a grounding member 4 installed in the spacing groove 34 and a positioning block 5 installed in the grounding member 4. In the illustrated embodiment of the present disclosure, the plurality of conductive terminals 3 include a plurality of signal terminals and a plurality of ground terminals. A cross section of the grounding member 4 is U-shaped, and includes a first extension wall 41, a second extension wall 42 opposite to the first extension wall 41, and a connecting wall 43 connecting the first extension wall 41 and the second extension wall 42. The first extension wall 41 and/or the second extension wall 42 are in contact with the ground terminals. In addition, the first extension wall 41 and the second extension wall 42 include protruding strips 411, 421 to press against the first insulating block 311 and the second insulating block 321, respectively, in order to increase the holding force. In addition, the grounding member 4 also includes a positioning slot 44 which opens backwardly. In the illustrated embodiment of the present disclosure, the positioning block 5 includes a main body portion 51 clamped in the positioning slot 44 and side portions 52 located at two ends of the main body portion 51. The side portions 52 extend beyond the grounding member 4 along a left-right direction.

In the illustrated embodiment of the present disclosure, the first outer surface 211 of the electrical connector 100 is disposed on the first shell portion 21 of the shielding shell 2. Of course, in other embodiments, the first outer surface 211 of the electrical connector 100 may also be disposed on the insulating body 1 (for example, a top surface of the insulating body 1). The electrical connector 100 further includes a fool-proof protrusion 6 protruding beyond the first outer surface 211 in a fourth direction A4. The fool-proof protrusion 6 is located adjacent to the mating surface 11 and adapted to prevent the mating connector 200 from being inserted into the electrical connector 100 at a wrong angle at an initial insertion stage of the mating connector 200. It is understandable to those skilled in the art that a specific distance of the fool-proof protrusion 6 adjacent to the mating surface 11 can be flexibly adjusted according to the actual situation. The third direction A3 is opposite to the fourth direction A4, for example, the third direction A3 is a top-to-bottom direction, and the fourth direction A4 is a bottom-to-top direction. Referring to FIGS. 9 and 10, in the illustrated embodiment of the present disclosure, the mating connector 200 includes a tongue plate 201 and a positioning protrusion 202. The tongue plate 201 is parallel to the positioning protrusion 202 and located on one side (for example, an upper side or a lower side) of the positioning protrusion 202. A plurality of conductive pads (not shown) for mating with the contact portions 33 of the electrical connector 100 are provided on the tongue plate 201. Referring to FIG. 9, when the mating connector 200 is inserted into the electrical connector 100 at a correct angle, the tongue plate 201 is inserted into the slot 130, the conductive pads are in contact with the conductive terminals, and the positioning protrusion 202 is inserted into the receiving groove 20. Referring to FIG. 10, when the mating connector 200 is inserted into the electrical connector 100 at a wrong angle (for example, the mating connector 200 is turned over by 180 degrees), the tongue plate 201 corresponds to a place where the slot 130 is located, the positioning protrusion 202 is located on a side of the first shell portion 21 away from the slot 130. Under this condition, the fool-proof protrusion 6 is located on an insertion path of the positioning protrusion 202, so that the positioning protrusion 202 can prevent the mating connector 200 from being inserted into the electrical connector 100 at the wrong angle. Preferably, the fool-proof protrusion 6 is disposed adjacent to the mating surface 11, so that the mating connector 200 can be prevented as early as possible when it is inserted at the wrong angle.

The fool-proof protrusion 6 has a first end edge 61 located at a most end thereof along the first direction A1. The first outer surface 211 and the first end edge 61 are arranged one behind the other along the second direction A2. The mating surface 11 and the first end edge 61 are also arranged one behind the other along the second direction A2.

Referring to FIGS. 1 to 5, in a first embodiment of the present disclosure, the fool-proof protrusion 6 and the shielding shell 2 are integrally formed. For example, the fool-proof protrusion 6 is integrally stamped from the first shell portion 21 to save cost. The first shell portion 21 defines an opening 217 located behind the beam 216 along the second direction A2. The opening 217 is formed by stamping the fool-proof protrusion 6 on the first shell portion 21. Specifically, the first shell portion 21 includes a first end surface 213 adjacent to the mating surface 11 along the first direction A1. The first shell portion 21 includes a beam 216 which is located closer to the mating surface 11 than the fool-proof protrusion 6 along the first direction A1. In the illustrated embodiment of the present disclosure, the beam 216 has a front end surface 2161 located at a most end thereof along the first direction A1. The front end surface 2161 is flush with the first end surface 213. With this arrangement, when the mating connector 200 is inserted into the electrical connector 100 at a wrong angle, the fool-proof protrusion 6 only generates a horizontal force, thereby reducing the risk of failure of the fool-proof protrusion 6 being bent by the mating connector 200. In the first embodiment of the present disclosure, the number of the fool-proof protrusions 6 is only one and is located in the middle of the first shell portion 21 along a width direction W-W of the first shell portion 21.

The second shell portion 22 protrudes beyond the first shell portion 21 along the first direction A1. The second shell portion 22 includes a second end surface 223 located at a most end thereof along the first direction A1. The second end surface 223 is located in front of the mating surface 11 along the first direction A1.

Referring to FIG. 11 and FIG. 12, the fool-proof protrusion 6 includes a first curved portion 62, a second curved portion 63, and a middle portion 64 connecting the first curved portion 62 and the second curved portion 63. The first curved portion 62 is located on one side of the middle portion 64 and connected to the first shell portion 21. The second curved portion 63 is located on another side of the middle portion 63 and connected to the first shell portion 21.

The first curved portion 62 includes a first arc segment 621 connected to the first shell portion 21 and a second arc segment 622 connected to the first arc segment 621. The first arc segment 621 has a first center O1 located outside the first curved portion 62. The second arc segment 622 has a second center O2 located inside the first curved portion 62.

The second curved portion 63 includes a third arc segment 631 connected to the first shell portion 21 and a fourth arc segment 632 connected to the third arc segment 631. The middle portion 64 is connected between the second arc segment 622 and the fourth arc segment 632. The third arc segment 631 has a third center O3 located outside the second curved portion 63. The fourth arc segment 632 has a fourth center O4 located inside the second curved portion 63.

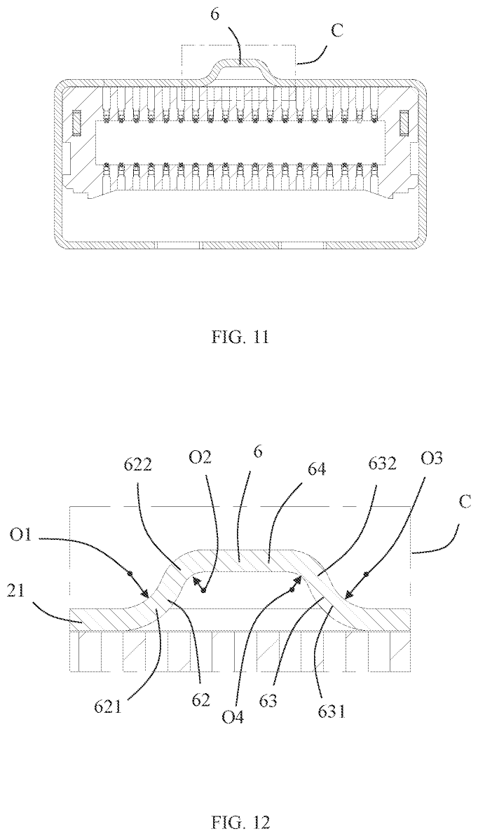

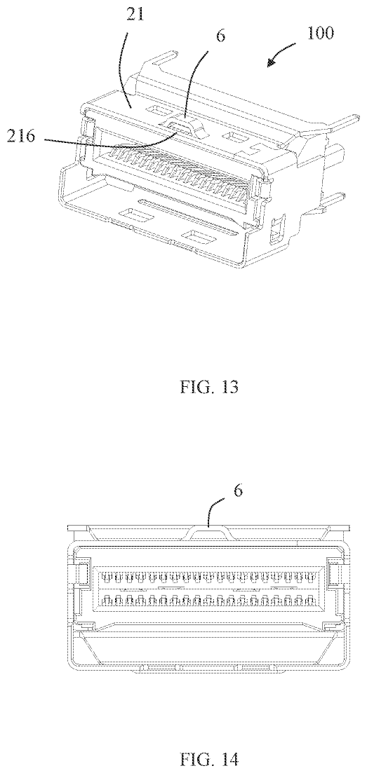

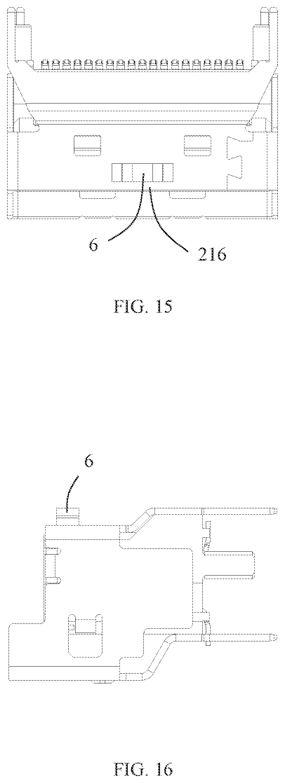

Referring to FIG. 13 to FIG. 16, a second embodiment of the present disclosure discloses an electrical connector 100 which is similar to that in the first embodiment. The structures of the electrical connector 100 in the second embodiment can refer to the description of the electrical connector 100 in first embodiment, which will not be repeated in the present disclosure.

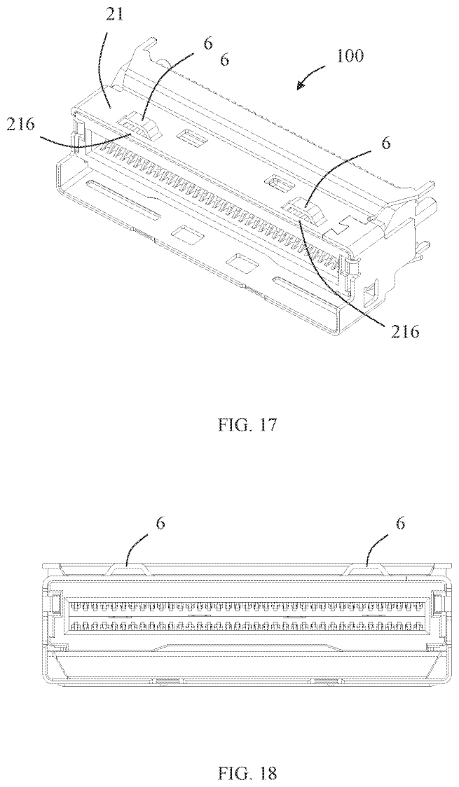

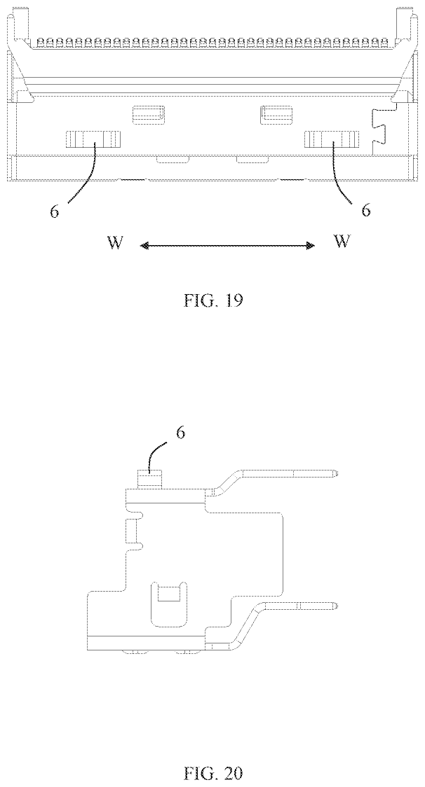

Referring to FIG. 17 to FIG. 20, a third embodiment of the present disclosure discloses an electrical connector 100 which is similar to these in the first embodiment and the second embodiment. The main difference is that the electrical connector 100 in the third embodiment has two fool-proof protrusions 6. The two fool-proof protrusions 6 are arranged on two sides of the first shell portion 21 along a width direction W-W of the first shell portion 21.

According to the present disclosure, the first end surface 213 of the shielding shell 2 and the first end edge 61 of the fool-proof protrusion 6 are arranged one behind the other along the second direction A2, which reduces the excessive impact on sensitive dimensions of a frame opening of the shielding shell 2 when forming the fool-proof protrusion 6, thereby improving the structural stability of the shielding shell 2. In the present disclosure, by setting the beam 216, the impact on the frame opening when the fool-proof protrusion 6 is formed is reduced, which is beneficial to improve the yield rate of the product.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
an insulating body comprising a mating surface and a slot extending through the mating surface along a first direction, the slot being configured to receive a part of a mating connector along a second direction opposite to the first direction;
a plurality of conductive terminals, each conductive terminal comprising a contact portion extending into the slot; and
a shielding shell shielded on the insulating body, a receiving groove for receiving a part of the mating connector being formed between the shielding shell and the insulating body, the receiving groove being located outside the slot along a third direction which is perpendicular to the first direction and the second direction;
wherein the shielding shell comprises a first shell portion, the first shell portion comprises a first outer surface, a first end surface located adjacent to the mating surface along the first direction, and a fool-proof protrusion protruding beyond the first outer surface along a fourth direction which is opposite to the third direction; the fool-proof protrusion is located adjacent to the mating surface; the first outer surface and the receiving groove are located on opposite sides of the slot, respectively; the fool-proof protrusion has a first end edge located at a most end along the first direction; the first end surface and the first end edge are disposed one behind the other along the second direction; and the fool-proof protrusion is configured to prevent the mating connector from being inserted into the electrical connector at a wrong angle.

2. The electrical connector according to claim 1, wherein the mating surface and the first end edge are arranged in sequence along the second direction.

3. The electrical connector according to claim 1, wherein the fool-proof protrusion and the shielding shell are integrally formed.

4. The electrical connector according to claim 3, wherein the shielding shell is made of a metal material, and the fool-proof protrusion is integrally stamped from the first shell portion.

5. The electrical connector according to claim 1, wherein the first shell portion comprises a beam which is located closer to the mating surface than the fool-proof protrusion along the first direction.

6. The electrical connector according to claim 5, wherein the beam has a front end surface located at a most end thereof along the first direction; and the front end surface is flush with the first end surface.

7. The electrical connector according to claim 5, wherein the shielding shell is made of a metal material, and the fool-proof protrusion is integrally stamped from the first shell portion;
the first shell portion defines an opening located behind the beam along the second direction, and the opening is formed by stamping the fool-proof protrusion on the first shell portion.

8. The electrical connector according to claim 1, wherein only one fool-proof protrusion is provided, and the fool-proof protrusion is disposed in a middle of the first shell portion along a width direction of the first shell portion; or
two fool-proof protrusions are provided, and the two fool-proof protrusions are disposed on two sides of the first shell portion along a width direction of the first shell portion.

9. The electrical connector according to claim 1, wherein the insulating body comprises a first wall portion and a second wall portion opposite to the first wall portion, the slot is located between the first wall portion and the second wall portion;
the shielding shell comprises a second shell portion opposite to the first shell portion, the first shell portion shields the first wall portion, the second shell portion shields the second wall portion, the receiving groove is located between the second wall portion and the second shell portion, the second shell portion defines at least one locking hole in communication with the receiving groove, the at least one locking hole is adapted to lock with the mating connector; the second shell portion protrudes beyond the first shell portion along the first direction; the second shell portion comprises a second end surface located at a most end of the second shell portion along the first direction; and the second end surface is located in front of the mating surface along the first direction.

10. The electrical connector according to claim 9, wherein the electrical connector comprises a first terminal module and a second terminal module which are assembled to the insulating body, the first terminal module comprises a first insulating block and a plurality of first conductive terminals fixed to the first insulating block, the second terminal module comprises a second insulating block and a plurality of second conductive terminals fixed to the second insulating block, the first conductive terminals comprise a plurality of first elastic arms protruding beyond the first wall portion and extending into the slot, and the second conductive terminals comprise a plurality of second elastic arms protruding beyond the second wall portion and extending into the slot.

11. The electrical connector according to claim 10, wherein a spacing groove is formed between the first insulating block and the second insulating block; and wherein the electrical connector further comprises a grounding member installed in the spacing groove.

12. The electrical connector according to claim 11, wherein the grounding member has a U-shaped cross-section and defines a positioning slot; and wherein the electrical connector further comprises a positioning block clamped in the positioning slot.

13. The electrical connector according to claim 1, wherein the fool-proof protrusion comprises a first curved portion, a second curved portion, and a middle portion connecting the first curved portion and the second curved portion; the first curved portion is located on one side of the middle portion and connected with the first shell portion; and the second curved portion is located on another side of the middle portion and connected with the first shell portion.

14. The electrical connector according to claim 13, wherein the first curved portion comprises a first arc segment connected to the first shell portion and a second arc segment connected to the first arc segment; the first arc segment has a first center located outside the first curved portion; the second arc segment has a second center located inside the first curved portion; and
wherein the second curved portion comprises a third arc segment connected to the first shell portion and a fourth arc segment connected to the third arc segment; the middle portion is connected between the second arc segment and the fourth arc segment; the third arc segment has a third center located outside the second curved portion; the fourth arc segment has a fourth center located inside the second curved portion.

15. An electrical connector, comprising:
an insulating body comprising a mating surface and a slot extending through the mating surface along a first direction, the slot being configured to receive a part of a mating connector along a second direction opposite to the first direction;
a plurality of conductive terminals, each conductive terminal comprising an elastic contact portion extending into the slot; and
a shielding shell made of a metal material and shielded on the insulating body, a receiving groove for receiving a part of the mating connector being formed between the shielding shell and the insulating body, the receiving groove being located outside the slot along a third direction which is perpendicular to the first direction and the second direction;
wherein the shielding shell comprises a first shell portion, the first shell portion comprises a first outer surface, a first end surface located adjacent to the mating surface along the first direction, and a fool-proof protrusion protruding beyond the first outer surface along a fourth direction which is opposite to the third direction; the fool-proof protrusion is integrally stamped from the first shell portion and located adjacent to the mating surface; the first outer surface and the receiving groove are located on opposite sides of the slot, respectively; the fool-proof protrusion has a first end edge located at a most end along the first direction; the first end surface and the first end edge are located on different planes; and the fool-proof protrusion is configured to prevent the mating connector from being inserted into the electrical connector at a wrong angle.

16. The electrical connector according to claim 15, wherein the first shell portion comprises a beam which is located closer to the mating surface than the fool-proof protrusion along the first direction.

17. The electrical connector according to claim 16, wherein the beam has a front end surface located at a most end thereof along the first direction; and the front end surface is flush with the first end surface.

18. The electrical connector according to claim 16, wherein the first shell portion defines an opening located behind the beam along the second direction, and the opening is formed by stamping the fool-proof protrusion on the first shell portion.

19. The electrical connector according to claim 15, wherein the fool-proof protrusion comprises a first curved portion, a second curved portion, and a middle portion connecting the first curved portion and the second curved portion; the first curved portion is located on one side of the middle portion and connected with the first shell portion; and the second curved portion is located on another side of the middle portion and connected with the first shell portion.

20. The electrical connector according to claim 19, wherein the first curved portion comprises a first arc segment connected to the first shell portion and a second arc segment connected to the first arc segment; the first arc segment has a first center located outside the first curved portion; the second arc segment has a second center located inside the first curved portion; and
wherein the second curved portion comprises a third arc segment connected to the first shell portion and a fourth arc segment connected to the third arc segment; the middle portion is connected between the second arc segment and the fourth arc segment; the third arc segment has a third center located outside the second curved portion; the fourth arc segment has a fourth center located inside the second curved portion.
